(19) United States
(12) Patent Application Publication
(10) Pub. No.: US 2008/0144803 A1
(43) Pub. Date: Jun. 19, 2008

(54) DYNAMIC AGENT SKILL BALANCING

(76) Inventors: Peeyush Jaiswal, Boca Raton, FL (US); Naveen Narayan, Flower Mound, TX (US)

Correspondence Address: DUKE W. YEE, YEE AND ASSOCIATES, P.C., P.O. BOX 802333, DALLAS, TX, 75380, US

(21) Appl. No.: 11/611,350

(22) Filed: Dec. 15, 2006

(51) Int. Cl. H04M 3/00

(52) U.S. Cl. 379/265.12

(57) ABSTRACT

A computer implemented method, data processing system, and computer program product for dynamically balancing call loads among call center resources when a call load reaches a threshold. Responsive to receiving an incoming call at a call center, a target call center resource group is determined to handle the incoming call. A determination is then made as to whether a call load of the target call center resource group is above a threshold. If the call load is above the threshold, the least utilized call center resources in the call center are located. The resources in the least utilized call center resources which have a same skill set of the target call center resources are then identified. The identified resources are then assigned to the target call center resource group.

### BACKGROUND OF THE INVENTION

1. Field of the Invention

The present invention relates generally to an improved data processing system, and in particular to a computer implemented method, data processing system, and computer program product for dynamically balancing call loads among call center resources when a call load reaches a threshold.

2. Description of the Related Art

In customer support operations in a call center, it is customary to assign skill levels to call support personnel. Skill levels of the support personnel are used to determine the appropriate call support agent who is capable of handling a customer call. For example, level-1 support agents may be assigned a skill set of basic diagnostic and remediation procedures only. Level-2 support agents may have more specialized skill sets, and may be assigned a skill set in a particular area of support. Calls may be routed to a level-1 support agent if the skill set level of the level-1 agent allows the agent to handle the customer call. If the call is more complex, however, the assistance of level-2 agents may be required, and the call is instead directed to the appropriate level-2 specialist.

Callers to a call center may also be profiled and identified as being a premier caller or a non-premier caller. For instance, when receiving a call, the caller may supply identifying profile information to the support personnel, such as name, address, and product identification. This information may be captured by a support agent using a computer-based software application, such as applications which store data provided by the support agent by filling in a form. If the administrator of the call center prefers that calls received by callers which have been identified as premier callers should be given priority over non-premier callers, the calls from the premier callers are answered first, and calls from non-premier callers are placed in a wait queue that is longer than the premier wait queue. In addition, agents assigned as having higher skill sets (e.g., level-2 agents) may handle the premier calls, and non-premier calls are handled by agents assigned as having lower skills (e.g., level-1 agents).

A problem that exists with current call distribution methods is that when a call center receives a large amount of calls of a specific type (e.g., level-1 or level-2 , premier or non-premier, etc.), there may be not be enough call support agents with the appropriate skill set that are presently assigned to handle the large number of calls in a timely manner. Consider, for example, a case in which many level-1 calls are received at the call center, and there are not enough level-1 agents to handle the calls in a timely manner. The level-2 agents in the call center have been assigned specialized skill sets, rather than the lower skill sets of the level-1 agents. In such a case, current call load distribution methods require that the call center administrator distribute the call load manually, such as by staffing more level-1 agents to handle the increased level-1 call load. If additional staffing is not an option to the administrator, the administrator must manually change the skill sets assigned to some of the level-2 agents in order for the level-1 calls to be routed to the level-2 agents.

### SUMMARY OF THE INVENTION

The illustrative embodiments provide a computer implemented method, data processing system, and computer program product for dynamically balancing call loads among call center resources when a call load reaches a threshold. Responsive to receiving an incoming call at a call center, a target call center resource group is determined to handle the incoming call. A determination is then made as to whether a call load of the target call center resource group is above a threshold. If the call load is above the threshold, the least utilized call center resources in the call center are located. The resources in the least utilized call center resources which have a same skill set of the target call center resources are then identified. The identified resources are then assigned to the target call center resource group.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed call support system network in accordance with the illustrative embodiments;

FIG. 2 is an exemplary block diagram of a call center computing system in accordance with the illustrative embodiments; and

FIG. 3 is a flowchart of a process for dynamically balancing call loads among call center resources when a call load reaches a threshold in accordance with the illustrative embodiments.

### DETAILED DESCRIPTION OF THE PREFERRED EMBODIMENT

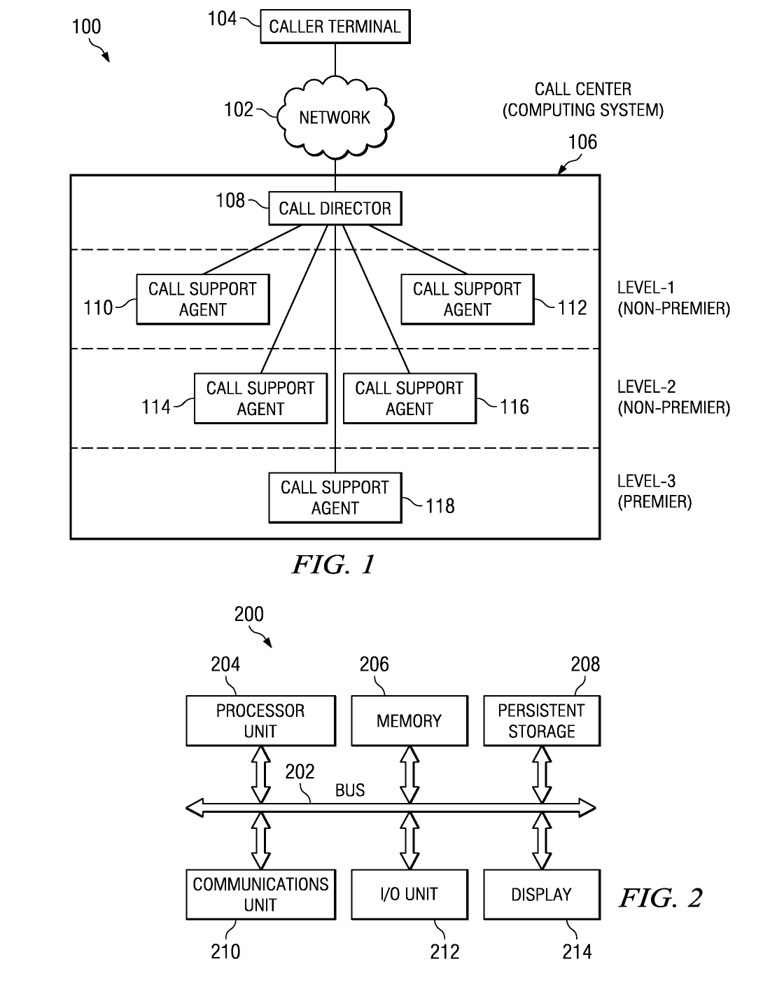

FIG. 1 is an exemplary block diagram of a distributed call support system network in accordance with the illustrative embodiments. As shown in FIG. 1, the distributed network 100 includes communication network 102, caller terminal 104, and call center 106. Caller terminal 104 may be any type of mechanism capable of sending and receiving communication signals by way of a wired or wireless communication connection with the communication network 102. Caller terminal 104 may be, for example, a conventional land-line telephone, a cellular telephone, an Internet based telephone device, a computer having a microphone or other audio input device, and the like.

Communication network 102 may be any type of network that provides communication pathways between caller terminal 104 and call center 106. Communication network 102 may be, for example, a conventional telephone network, cellular telephone network, data network, satellite network, or the like, or any combination of one or more of these types of networks. For example, communication network 102 may be a conventional telephone network in which switches, routers, and the like, are used to route communication signals from a source terminal to a destination device or terminal. The routing of signals through a conventional telephone network is well known and thus, will not be further explained herein.

Call center 106 includes call director 108 and a plurality of call support agents 110-118. Call center 106 may further include computing devices and data storage (not shown) for controlling the operation of the call center 106 and storing data relevant to the operation of the call center 106.

Call director 108 typically receives calls from caller terminals, such as caller terminal 104. A call to call center 106 may be initiated, for example, by a caller entering an address of call center 106 via caller terminal 104, for example. As another example, the caller may initiate the call by dialing a telephone number associated with the call center 106.

A call routing software is used by call director 108 to determine which call support agents 110-118 may handle an incoming call. The call routing software performs various functions upon startup. For instance, the call routing software reads a list of all available call support agents within the call center, a list of available skill sets, and an agent-to-skill mapping which allows for determining which skill set applies to which available agent. The skill set of an agent is used to determine whether or not the agent may handle an incoming call.

When an incoming call is received, the incoming call may be identified by call director 108 based on the type of call (e.g., a call for technical assistance, a call for billing questions, etc.), the type of caller placing the call (e.g., a premier caller may be provided level-3 support rather than level-1 support), and the like. Once the type of call or the caller is known, the call routing software determines which of call support agents 110-118 has the necessary skill set to handle the incoming call. For example, if the incoming call is from a non-premier caller who has a basic technical question (i.e., level-1 question), the call routing software identifies that this call may be handled by an agent with a basic skill set, and therefore assigns the first available call support agent in the level-1 group, such as call support agent 110, to the incoming call. It should be noted that while the present invention is described in terms of tiers of support, e.g., level-1 and level-2 support, the present invention is not limited to such. Rather, these designations are only provided for illustration in order to differentiate between human operators rather than to imply any particular limitations of the present invention.

The type of caller may be identified by coupling call director 108 to a caller ID device (not shown) that is capable of obtaining information about the caller based on the caller terminal address. For example, the call signals provided by caller terminal 104 may include a telephone number of caller terminal 104. The caller ID device may receive this telephone number of caller terminal 104 and search a database that provides the caller name, address, telephone number, and any other pertinent caller profile information. The call is then placed in a queue (e.g., level-1 or 2 queues for a non-premier caller, level-3 queue for a premier caller, etc.) awaiting the first free call support agent in that agent group. When one of the call support agents in that agent group becomes free (i.e., is no longer involved in handling a call), the next call in the queue is forwarded to the free call support agent.

The call routing software is also used by call director 108 to identify all route points in call center 106. The route points are queues where a call sits awaiting distribution to an agent. Route points may be controlled by Computer Telephony Integration (CTI) servers or the switch. As soon as a call lands on a route point, the CTI software or the switch takes control of the call and routes the call to a call support agent. The call routing software monitors the route points and calculates the volume of pending calls (call load) in the call center. By monitoring the route points, the call load of each call type on the agent group handling that call type may be determined.

The call routing software also allows an administrator to set a threshold level for call load distribution purposes. The threshold level specifies an acceptable number of calls which may be routed to an agent group within a defined time period (e.g., X number of calls per one half hour). A threshold may be set for all agent groups, or different thresholds may be used for each agent group. If the call routing software determines that the call load for any call type exceeds the threshold level for an agent group (i.e., the high call volume group), the call routing software scans the routing points to locate the least utilized agent group in the call center. In other words, the agent group which has the smallest call load is located by the call routing software.

Upon locating the least utilized agent group, the call routing software may use business rules to obtain a list of agents in the least utilized agent group who can handle the calls for the high call volume group. The business rules may refer to the CTI route point programming. The call routing software may query the CTI servers to determine the least utilized agent groups. When queried, the CTI server programming (i.e., the business rules) determines which agent group is the least utilized group.

The call routing software then determines the skill set of the high call volume group. The call routing software tries to match the skill set of agents in the least utilized group with the skill set of the high call volume group. If the skill set of one or more agents in the least utilized agent group meets the skill set required by the support level agent group with the high call volume, the call routing software allocates these agents to the high call volume group. Thus, more capable agents are dynamically added to the high call volume group, thereby ensuring that the high call volume group has the agents needed to handle the increased call load.

As the additional agents assist the high call volume group, the call routing software also monitors the call volume of the high call volume group to determine when the call load falls below the threshold level. Once the call load falls below the threshold level, the call routing software releases the additional agents from the high call volume group, and reassigns them back to their original agent group.

FIG. 2 is an exemplary block diagram of an exemplary call center computing system in accordance with the illustrative embodiments. In this illustrative example, data processing system 200 includes communications fabric 202, which provides communications between processor unit 204, memory 206, persistent storage 208, communications unit 210, I/O unit 212, and display 214.

Processor unit 204 serves to execute instructions for software, such as call routing software, which may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. Memory 206, in these examples, may be, for example, a random access memory. Persistent storage 208 may take various forms depending on the particular implementation. For example, persistent storage 208 may be, for example, a hard drive, a flash memory, a rewritable optical disk, a rewritable magnetic tape, or some combination of the above.

Communications unit 210, in these examples, provides for communications with other data processing systems or devices, such as caller terminal 104 in FIG. 1. In these examples, communications unit 210 is a network interface card. I/O unit 212 allows for input and output of data with other devices that may be connected to data processing system 200. For example, I/O unit 212 may provide a connection for user input though a keyboard and mouse. Further, I/O unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206.

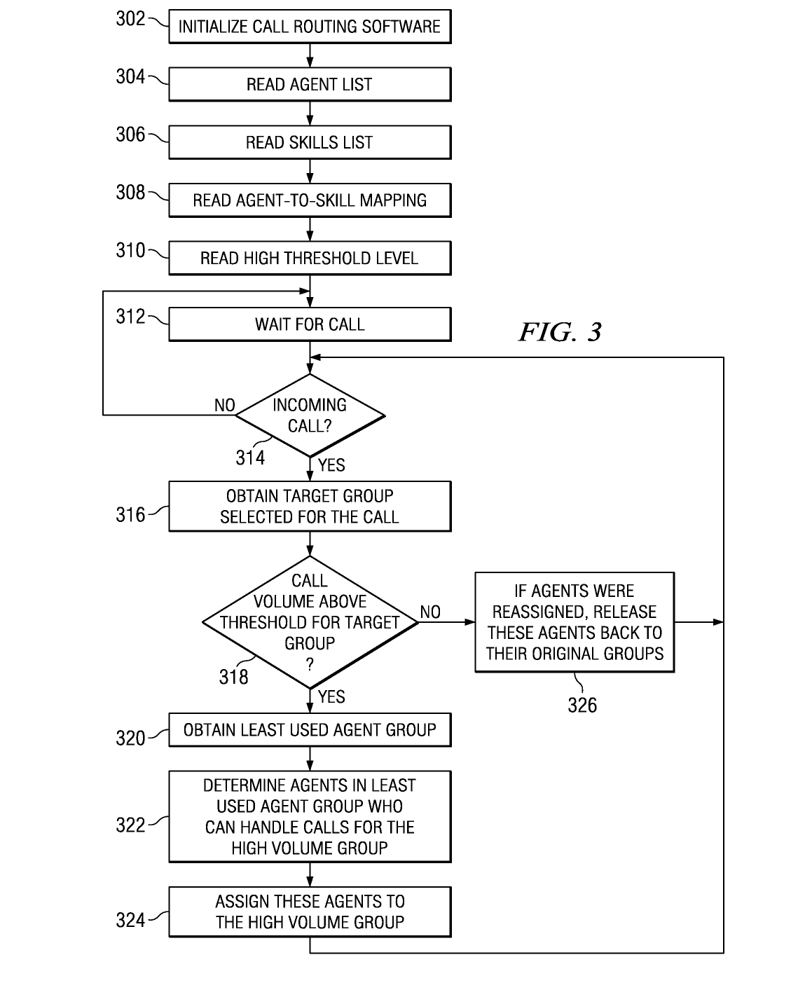

FIG. 3 is a flowchart of an exemplary process for dynamically balancing call loads among call center resources when a call load reaches a threshold in accordance with the illustrative embodiments. As shown in FIG. 3, the process begins with initializing the call routing software (step 302). Upon startup, the call routing software reads an agent list comprising all available agents in the call center (step 304), a skill list comprising all available skill sets in the call center (step 306), and an agent-to-skill mapping to identify which skill set belongs to which available agent (step 308). The call routing software also reads the high threshold level for the agent groups (step 310).

Next, the call routing software waits for an incoming call (step 312). A determination is made as to whether an incoming call has been received (step 314). If a call has not been received (‘no’ output of step 314), the process loops back to step 312 where the call routing software waits for a call. If a call has been received (‘yes’ output of step 314), the call routing software identifies the target call support agent group in the call center which may handle the incoming call (step 316).

The call routing software then makes a determination whether the call volume for the target call support agent group is above the high threshold level (step 318). If the call volume is above the threshold (‘yes’ output of step 318), the call routing software identifies the least utilized call support agents in the call center (step 320). The call routing software then determines which agents in the group of least utilized agents are able to handle calls for the high volume agent group (step 322). Once the capable agents have been identified, the call routing software reassigns these agents to the high volume agent group (step 324), thereby balancing the available resources to the call volume. The process then returns to step 314 to wait for the next incoming call.

Turning back to step 318, if the call routing software determines that the call volume is not above the high threshold (‘no’ output of step 318), the call routing software releases those agents who were reassigned to handle the high call volume of another group back to their original call support groups (step 326). The process then returns to step 314 for the next incoming call.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for dynamically balancing call loads among call center resources, the computer implemented method comprising:
responsive to receiving an incoming call at a call center, determining a target call center resource group to handle the incoming call;
determining whether a call load of the target call center resource group is above a threshold;
if the call load is above the threshold, locating least utilized call center resources in the call center;
identifying resources in the least utilized call center resources which have a same skill set of the target call center resources; and
assigning the identified resources to the target call center resource group.

2. The computer implemented method of claim 1, further comprising:
if the call load is below the threshold, reassigning the identified resources to their original call center resource groups.

3. The computer implemented method of claim 1, wherein the identified resources handle incoming calls to the target call center resource group to balance the call load in the call center.

4. The computer implemented method of claim 1, wherein the determining step further includes:
monitoring each incoming call type in the call center; and
calculating the call load on each call center resource group handling each incoming call type.

5. The computer implemented method of claim 1, wherein the threshold is set by a call center administrator.

6. The computer implemented method of claim 1, wherein each call center resource group has a same threshold.

7. The computer implemented method of claim 1, wherein each call center resource group has a different threshold.

8. A data processing system for dynamically balancing call loads among call center resources, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to determine, in response to receiving an incoming call at a call center, a target call center resource group to handle the incoming call, determine whether a call load of the target call center resource group is above a threshold, locate least utilized call center resources in the call center if the call load is above the threshold, identify resources in the least utilized call center resources which have a same skill set of the target call center resources, and assign the identified resources to the target call center resource group.

9. The data processing system of claim 8, wherein the processing unit further executes the computer usable code to reassign the identified resources to their original call center resource groups if the call load is below the threshold.

10. The data processing system of claim 8, wherein the identified resources handle incoming calls to the target call center resource group to balance the call load in the call center.

11. The data processing system of claim 8, wherein the computer usable code to determine whether a call load of the target call center resource group is above a threshold further comprises computer usable code to monitor each incoming call type in the call center, and calculate the call load on each call center resource group handling each incoming call type.

12. The data processing system of claim 8, wherein each call center resource group has a same threshold.

13. The data processing system of claim 8, wherein each call center resource group has a different threshold.

14. A computer program product for dynamically balancing call loads among call center resources, the computer program product comprising:
a computer usable medium having computer usable program code tangibly embodied thereon, the computer usable program code comprising:
computer usable program code for determining, in response to receiving an incoming call at a call center, a target call center resource group to handle the incoming call;
computer usable program code for determining whether a call load of the target call center resource group is above a threshold;
computer usable program code for locating least utilized call center resources in the call center if the call load is above the threshold;
computer usable program code for identifying resources in the least utilized call center resources which have a same skill set of the target call center resources; and
computer usable program code for assigning the identified resources to the target call center resource group.

15. The computer program product of claim 14, further comprising:
computer usable program code for reassigning the identified resources to their original call center resource groups if the call load is below the threshold.

16. The computer program product of claim 14, wherein the identified resources handle incoming calls to the target call center resource group to balance the call load in the call center.

17. The computer program product of claim 14, wherein the computer usable program code for determining whether a call load of the target call center resource group is above a threshold further includes:
computer usable program code for monitoring each incoming call type in the call center; and
computer usable program code for calculating the call load on each call center resource group handling each incoming call type.

18. The computer program product of claim 14, wherein the threshold is set by a call center administrator.

19. The computer program product of claim 14, wherein each call center resource group has a same threshold.

20. The computer program product of claim 14, wherein each call center resource group has a different threshold.
